(19) United States
(12) Patent Application Publication
(10) Pub. No.: US 2022/0095110 A1
(43) Pub. Date: Mar. 24, 2022

(54) DYNAMIC SCHEDULER FOR VERIFIED MOBILE DEVICE PREAUTHORIZED ACCESS POINT REQUEST

(71) Applicant: Anthony Mantovani, West Islip, NY (US)

(72) Inventor: Anthony Mantovani, West Islip, NY (US)

(21) Appl. No.: 17/025,321

(22) Filed: Sep. 18, 2020

(51) Int. Cl. H04W 12/08; H04W 12/06; H04W 12/63; G06F 16/9537; G06F 9/54

(52) U.S. Cl. CPC H04W 12/08; H04W 12/06; H04W 88/02; G06F 16/9537; G06F 9/547; H04W 12/63

(57) ABSTRACT

Methods and systems related to a dynamic scheduler for mobile device preauthorized access point requests are disclosed herein. One disclosed method comprises receiving a preauthorization request associated with a verified entity account and a first access point, executing, in response thereto a preauthorization request validation flow for the verified entity account, validating, in response to a completion thereof, the preauthorization request, and storing, in response to validating the preauthorization request, a first mobile device preauthorization in a database for a first mobile device. The first mobile device is associated with the verified entity account. The method also comprises dynamically updating, predicated on the first mobile device preauthorization being stored in the database and in response to receiving a valid check-in notification from the first mobile device, an access schedule for the first access point, and transmitting an access notification to the first mobile device in accordance with the access schedule.

### BACKGROUND

Access point bandwidth allocation is dependent upon the characteristics of the access point itself and the preferences of the access administrator. Bandwidth allocation is traditionally handled through scheduling, queues, or a combination thereof. The problem of limited bandwidth is often exacerbated through the imposition of serialized authorization checks that require serialized access to a channel of such limited bandwidth which adds to the total time for which that channel must be allocated for a given user.

Consider the example of a real estate open house in which the number of users that can access the property at a single time is limited. Traditional queue-based allocation produces a difficult situation because users appear for access without knowing how many other users will be attempting to access the same property at that time. Indeed the access administrator in this situation (i.e., the agent hosting the open house) will have no way of knowing how long the lines will be ahead of time or how long each user should be allowed access to the property for. Furthermore, each user may be required to fill out several forms prior to being authorized to access the property which creates dead space wasted time while not actually gaining access to the resource.

### SUMMARY

In a specific embodiment of the invention, a computer-implemented method is provided. The method comprises receiving a preauthorization request associated with a verified entity account and a first access point, executing, in response to receiving the preauthorization request, a preauthorization request validation flow for the verified entity account, validating, in response to a completion of the preauthorization request validation flow, the preauthorization request, and storing, in response to validating the preauthorization request, a first mobile device preauthorization in a database for a first mobile device. The first mobile device is associated with the verified entity account. The method also comprises dynamically updating, predicated on the first mobile device preauthorization being stored in the database and in response to receiving a valid check-in notification from the first mobile device, an access schedule for the first access point; and transmitting an access notification to the first mobile device in accordance with the access schedule.

In specific embodiments of the invention, a non-transitory computer-readable media accessible to one or more processors is provided. The computer-readable media stores instructions which, when executed by the one or more processors, implement a method comprising receiving a preauthorization request associated with a verified entity account and a first access point, executing, in response to receiving the preauthorization request, a preauthorization request validation flow for the verified entity account, validating, in response to a completion of the preauthorization request validation flow, the preauthorization request, storing, in response to validating the preauthorization request, a first mobile device preauthorization in a database for a first mobile device, wherein the first mobile device is associated with the verified entity account, dynamically updating, predicated on the first mobile device preauthorization being stored in the database and in response to receiving a valid check-in notification from the first mobile device, an access schedule for the first access point, and transmitting an access notification to the first mobile device in accordance with the access schedule.

In specific embodiments of the invention, a system is provided. The system comprises a mobile device, a database, one or more processors, and one or more non-transitory computer-readable media accessible to the system, and storing instructions which, when executed by the system, cause the system to: receive a preauthorization request associated with a verified entity account and an access point, wherein the verified entity account is associated with the mobile device; execute, in response to receiving the preauthorization request, a preauthorization request validation flow for the verified entity account; validate, in response to a completion of the preauthorization request validation flow, the preauthorization request; store, in response to validating the preauthorization request, a preauthorization for the mobile device in the database; receive a valid check-in notification from the mobile device; dynamically update, predicated on the preauthorization for the mobile device being stored in the database and in response to receiving the valid check-in notification, an access schedule for the access point; and transmit an access notification to the mobile device in accordance with the access schedule.

### BRIEF DESCRIPTION OF THE DRAWINGS

FIG. 1 includes a flow chart for a set of method in accordance with specific embodiments of the invention disclosed herein.

FIG. 2 includes a block diagram representing systems in accordance with specific embodiments of the invention disclosed herein.

FIG. 3 includes a block diagram of an example of the flow of information stored and retrieved from different mobile devices and databases of a system, in accordance with specific embodiments of the invention.

### DETAILED DESCRIPTION

Methods and systems in accordance with the summary above are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

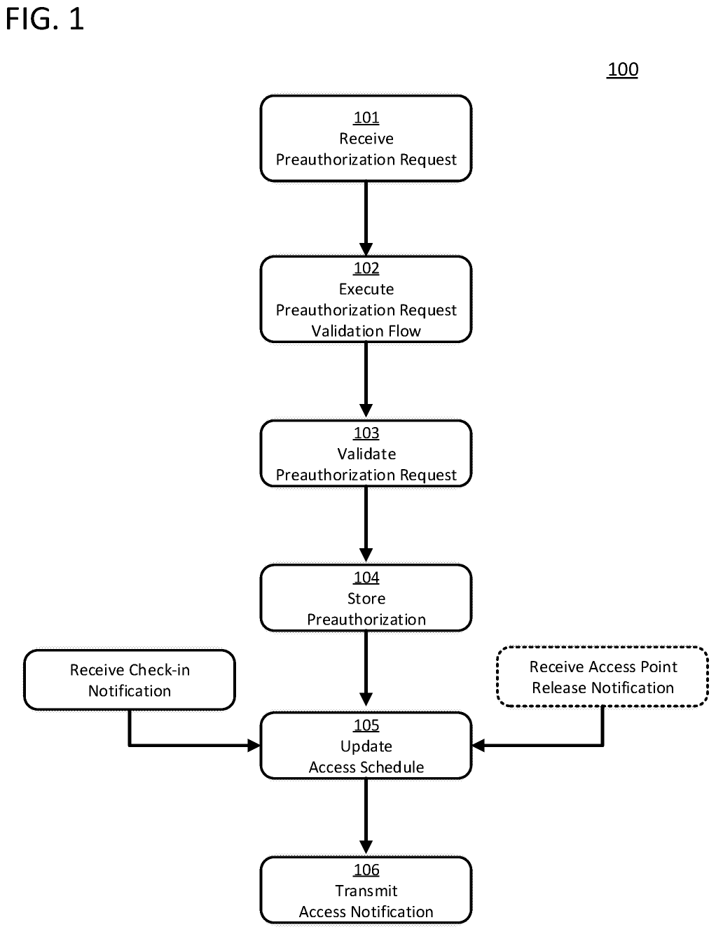

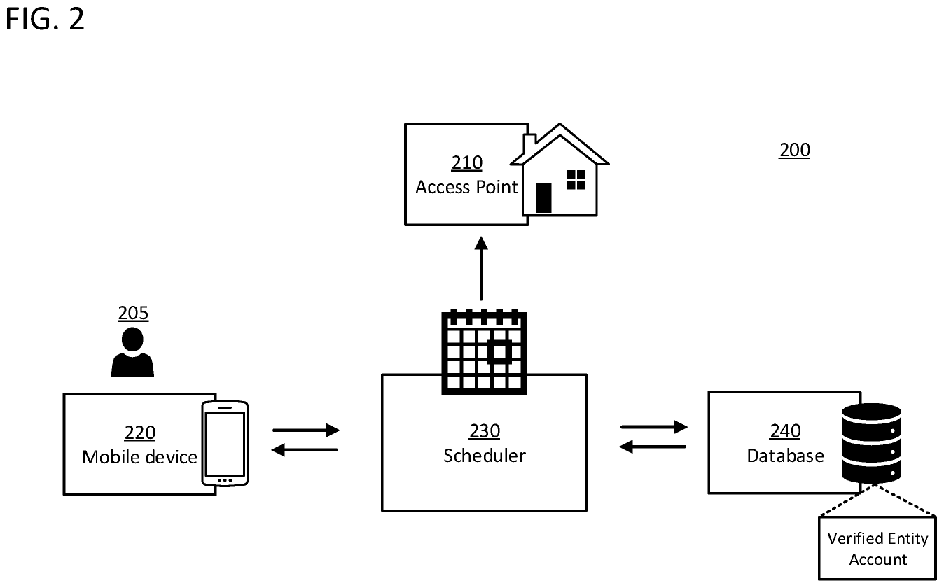

FIG. 1 includes a flow chart 100 for a set of method in accordance with specific embodiments of the invention disclosed herein. The methods can be computer-implemented executed by a system in accordance with block diagram 200 in FIG. 2. Access and interaction with the system can be via interfaces on a proprietary application running on a mobile device, via web access, via third party platforms or applications, and/or via any other interaction means such as text messages, e-mails, phone calls, and the like. The system can include a dynamic scheduler 230 for generating and updating an access schedule for an access point 210. The system can predicate scheduling on the receipt of both a valid check-in notification received from a mobile device 220 and the storage of a preauthorization from the mobile device in a database 240. Specific embodiments disclosed by flow chart 100 and block diagram 200 can therefore both efficiently allocate access to the access point, prevent users from having to be physically queued, and allow an access administrator to assure that users have been preauthorized before they are provided with access without having to serially conduct a preauthorization flow with the actual execution of the access schedule. Throughout this disclosure the example of an open house in which an agent is the access administrator, visitors are the users, and the access point is the home, will be used as an example implementation of the disclosed technology. However, the disclosed technology is broadly applicable to numerous other environments as will be apparent from the disclosure below.

The methods of flow chart 100 can be instantiated using computer-readable media and one or more processors. The computer-readable media can be non-transitory. The computer-readable media can be accessible to one or more processors and store instructions which, when executed by the one or more processors, implement a method such as the methods represented by flow chart 100. The processors and computer-readable media can be located in a cloud architecture that is accessible to a set of client devices. The processors and computer-readable media can also, or in the alternative, be located on the client devices. The processors and computer-readable media can also, or in the alternative, be located on an external server. The processors and computer-readable media can also, or in the alternative, be distributed among the different elements of the system, such as servers and user devices.

Flow chart 100 begins with a step 101 of receiving a preauthorization request associated with a verified entity account and a first access point. In block diagram 200 illustrated in FIG. 2, a preauthorization request could be received from mobile device 220, and could be, for example, a preauthorization request from user 205 for access to access point 210. User 205 can be the owner of, or otherwise be associated with, mobile device 220. The preauthorization request can be received by a scheduler 230. Scheduler 230 can be implemented as a dedicated hardware component of the system, such as a server or computing device, or can be a software module of the system implemented via one or more processors accessing instructions stored in memory. The scheduler can be implemented in a remote server. The scheduler can be implemented in a mobile device, such as for example a mobile device associated to the access administrator. The scheduler can be cloud-implemented or use any kind of shared infrastructure to operate. The scheduler can be implemented in a distributed manner among the elements of the system, including user's devices, access administrator's devices, servers, etc.

A preauthorization request can be associated with a given access point in that the request can be for authorization to access the given access point. In the example of an open house, a preauthorization request from a user would be associated to the house (the access point) that the user is interested in visiting. An access point, such as access point 210, can be any point that a user can access, such as a house in an open house. For example, an access point can be any place, a building, a room within a house or a building, a park, a gym, a hospital, a school, etc. The access point can be a point where access is restricted or controlled, and authorization may be necessary in order to access it, such as a private property or business, a shared room within a building, etc. An access point can also be an object, such as a shared computer or equipment, where a user may need to get into a queue and be preauthorized in order to use it.

A preauthorization request can be any request, such as a request from user 205 and/or mobile device 220, to obtain preauthorization to proceed with a given action, such as accessing an access point. For example, a preauthorization request can be a request from a user 205 to sing up for an open house, and the physical location of the open house can be the access point 210. Alternatively, a preauthorization request can be a request from a user to access or reserve a conference room in a shared office space, a request to access a hospital, a gym, or any other business or property, etc.

The preauthorization request can be associated with an entity account. An entity account can be an account associated to a user, such as user 205. An entity account can be, in the alternative or in combination, an account associated with a mobile device, such as mobile device 220. An entity account can be created by a user, such as user 205, when access to the system is desired or when the user registers in the system for the first time. The entity account can be created via an interface, for example an interface provided via a proprietary application running on mobile device 220 or a web portal. An entity account can also be created by accessing a link, button, or other interface in third-party applications or platforms associated with the system, or in social media platforms, browsers, search engines, etc. In the example of an open house, the user could create an account directly on an application or web page of the system, or by accessing the system through related platforms such as online real estate listing websites or real estate price tracking websites, and the like.

Alternatively or in combination, an access administrator can provide directions and/or links to create the account. For example, an agent could send an e-mail with a listing to a user for an open house, along with a link or guidelines to create an account with the system. To create an entity account, a user may be required to provide information, such as name, phone number or any other necessary information. The user may also be required to provide information about the mobile device being used, in order to associate it to the account.

An entity account can be verified to become a verified entity account. Verified entity accounts can be stored in a database, such as database 240. A preauthorization request can then be associated with the verified entity account. The entity account can be verified to become a verified entity account via various verification flows. For example, the entity account can be verified via e-mail, by confirming an e-mail address provided, for example, by accessing a link or interacting with a button in an e-mail from the system. The entity account can also be verified via a phone number, by texting a code or sending a link for the user to interact with. A verification flow could also include a self-taken picture, or the scanning of an ID document or other reliable document such as a credit card. Communications between the user and the system once an entity account is created could also be used to affirm that the entity account is a verified entity account. For example, once an entity account is created, an entry can be created in the database for the entity. The user can then login to the system, via a phone application or web access, and interact with the system. The interaction could lead the verification of the entity account. Multiple verification flows could be implemented to verify an entity account and the examples provided herewith are for explicative purposes only. Any flow can be carried out in order to confirm that the user is real, that the mobile device is reliable, etc. In this way, when a preauthorization request is received by the system, such preauthorization request can be associated with a verified entity account.

A verified entity account can be an existing account already stored in the database, for example by the process described above, or can be a new account created as a result of the preauthorization request process. In specific embodiments of the invention, the preauthorization request can be received once the account has been verified by the system. Therefore, in specific embodiments of the invention, when an attempt is made to obtain preauthorization, but no verified entity account exists, the system can guide a user through a verification flow before a complete request is received. For example, a user may be offered guidelines to register in the system, by clicking on a link in an e-mail, confirming an email address, typing a token or code received in their phones, etc.

The preauthorization request can be received via a dedicated system interface. The dedicated interface can be accessed for example, via an application running on mobile device 220, a web portal, a button or link on an email or text message, etc. The dedicated interface can enable a user, such as user 205 to perform other actions related to the potential preauthorization request. In the example of an open house, the dedicated interface can provide the user with options to browse open houses, establish search criteria, for example based on location, size, price, etc. The user can be able to select, view, save, or send preauthorization requests for multiple access points, among other actions. The user can be able to save search criteria and be notified when open houses that match the criteria are listed.

The dedicated interface could also allow an access administrator to define features for the users. In the example of the open house, an agent can list or define properties of open house options ahead of time and add descriptions. Information such as address, date, time, etc. could also be provided. The system could be associated with third party databases and harvest information to be provided via the dedicated interface. The access to third-party databases could be via an applications programming interface (API). For example, a Multiple Listing Service (MLS) database could be accessed and information available in the database could be presented to the users of the system via the dedicated interface. In specific embodiments of the invention, the dedicated interface can be loaded upon clicking on a button on a third-party platform or external web page, such as a third-party listing or price tracking service. In specific embodiments of the invention, the preauthorization request can be instantiated by the interaction with external platforms directly without loading the dedicated system interface. The dedicated interface could also be loaded upon scanning a QR code or using any other technology such as NFC or image recognition. For example, a QR code can be made available at a location of a listing, such as on a “for sale” sign at a property, and users can scan it to access the dedicated system interface, view details, register, etc. In this way, the preauthorization request can be instantiated by a visually displayed encoding at the access point, such as the QR mentioned before, by a hyperlink on an external web page, by a user interface element on an application interface on a mobile device, etc.

Flow chart 100 continues with a step 102 of executing, in response to receiving the preauthorization request, a preauthorization request validation flow for the verified entity account. A preauthorization request validation flow can be triggered when a preauthorization request is received by the system and include sub-steps for validating the preauthorization request. For example, the preauthorization request validation flow can include requesting further information from the user, such as by providing forms to be filled out. The preauthorization request validation flow can also include providing signature documents to the user. The user can be able to print and scan the documents, or fill in or sing the documents electronically, for example via e-signature on their computer or mobile devices. The preauthorization request validation flow can also include requesting the user to scan their ID or other documents. In the example of the open house, the validation flow can include the signature of documents that would otherwise be signed in situ, such as documents related to contact details, financial information, disclosures, etc. In this way, the user can provide, and the access administrator can obtain and review, the information in advance, which can save time during the access point visit. This process can also reduce in-person contact and exchange of physical objects such as pens and papers during the access point visit, which can be advantageous in special circumstances such as under the coronavirus disease 2019 (COVID-19) pandemic social distancing and sanitizing recommendations.

A preauthorization request validation flow can be highly customizable. For example, an access administrator can define the preauthorization request validation flow ahead of time, by defining forms, documents, and information to be sent to a user once a preauthorization request is received. The preauthorization request validation flow can include receiving, with respect to a given access point, a preauthorization flow definition to define requirements for the preauthorization flow. For example, an access administrator can define specific flows for different access points at different times. In this way, the access administrator can define the specific requirements and documents to be sent out for signature on a case by case basis. The validation flow, including the documents to be filled out or signed, and the kind of information requested, can then be adjusted depending on the access point location, local requirements, the access administrator current needs, etc. An access administrator can define specific preauthorization request validation flows for different open houses or can define a default flow to be use for any listing by the access administrator. The configurability of the preauthorization request validation flow can be advantageous in that the circumstances for accessing a given access point can change and the flow can be adjusted accordingly. For example, due to the COVID-19, access administrators can require users to answer questions related to their exposure to the virus and symptoms. Such questions could be promptly included as part of the validation flow. This feature also reduces the in-person contact between access administrators and users before it is confirmed that the user is qualified to access the access point.

The preauthorization request validation flow could also include accessing external platforms or databases to partially fill in documents when they are sent to a user. In the example of an open house, documents to be sent to and/or received from a user interested in visiting a given house can be automatically filled out with the access point address, description, etc. when the open house is listed, for example by obtaining such information from MLS.

In specific embodiments of the invention the preauthorization request validation flow can take into account documents and/or information that the user has provided as part of a previous validation flow. For example, forms can be pre-filled with information obtained from the same user as part of a previous verification flow, and the user can merely confirm or update the information pre-filled instead of completely filling in the document with the same information. As another example, if the verification flow includes a requirement for the user to provide a copy of an ID or other document, a subsequent verification flow for the same user within a predetermined period of time can consider the same copy, instead of requiring the user to re-submit the same document.

Flow chart 100 continues with a step 103 of validating, in response to a completion of the preauthorization flow, the preauthorization request. The validation can include checking that documents have been correctly filled in and/or signed. The validation can also include an analysis of the information provided, for example to determine if the user is qualified to access the desired access point. The validation can also include the storing of the documents, forms, and information provided for review by an access administrator or future use. The validation can be performed automatically by the system, can require a human review, or both. For example, the system can have rules to determine when a request can be verified and/or to flag requests that need further review. The rules can be set by an access administrator or a designer of the system. If a request cannot be validated, for example because a document was not signed or there is a mismatch in the information provided, a user can be provided with a notification to correct the deficiencies on the request, or re-submit the request.

Once the preauthorization request is validated, the user can be authorized to access the access point. The validation of the preauthorization request can be beneficial in that the access administrator can have anticipated knowledge of the person who is going to access the access point. This can avoid the access of random users into the access point and can allow a system administrator to have a profile of the users and follow up with them, as well as exchange information. This can also avoid that users who do not qualify for accessing a given access point are given access to it.

Flow chart 100 continues with a step 104 of storing, in response to validating the preauthorization request, a first mobile device preauthorization in a database, wherein the first mobile device is associated with the verified entity account. Once the preauthorization request is validated the system can recognize the user, such as user 205, as a preauthorized user. Alternatively or in combination, the system can recognize the mobile device, such as mobile device 220, as a preauthorized mobile device. The preauthorization can be for the user, such as user 205, for the mobile device of the user, such as mobile device 220, for the entity account, or for a combination thereof. For example, the preauthorization can be for the mobile device, and the device can be associated with the user. The mobile device can be associated with the user via an ID of an application on the device, a phone number, a code, etc. The preauthorization could be for a mobile device associated with a given phone number, or for a specific mobile device such as by considering the IMEI number or some unique identification of the device from where the request was made. Alternatively, the preauthorization can be for the user or the verified entity account, and the user can be able to log-in in multiple devices, while the system recognizes the user as a verified user by verifying credentials, face recognition, security questions, etc.

The preauthorization can be stored in a database and/or using any kind of data storage technology, such as smart servers, cloud storage, intelligent storage, dedicated storage systems or formats, integrated storage, Logical Volume Management (LVM) tools, integrated or remote data storage, Cloud Integrated Storage (CIS), dedicated storage area networks (SAN), Network-attached storage (NAS), unified or multiprotocol storage, etc. The database or storage can be proprietary or not, for example, a shared storage service could be used by the system. The storage and retrieval of information from the database could be managed by a mobile device and/or a servers in the system, for example via a Database Management System (DBMS) or any software for managing databases. A query language, such as Structured Query Language (SQL), can be used to query the database. An API could also be used to interact with third party databases as will be explained in more detail below.

Flow chart 100 continues with a step 105 of dynamically updating, predicated on the first mobile device preauthorization being stored in the database and in response to receiving a valid check-in notification from the first mobile device, an access schedule for the first access point. A check-in notification from a user/mobile device can be provided to notify that the user arrived or is about to arrive at the access point. The check-in notification can be provided via an input on the user's mobile device. For example, an application on the mobile device can include a check-in interface, such as a button, for the user to activate when necessary. As another example, the user can access a link on an e-mail or message from the system with check-in instructions. Alternatively or in combination, check-ins can be automatic location based. For example, the GPS from the mobile device can be used to determine when the user has arrived to the access point location. Check-in notifications can also be provided via local sensing at the access point, such as through wi-fi or a similar system.

Users can also be able to provide check-in notifications via an interaction at the access point, for example, by scanning a QR code on the access point using their mobile devices, by bringing the mobile device to an NFC location, tagging an NFC beacon, the agent phones or a dedicated computer device, or by providing their phone number. As another example, a code can be displayed at the open house location and the user can provide a check-in notification by entering the code on an interface on their mobile devices or sending the code in a message to the access administrator. A check-in notification can also be provided via calls, e-mails, text messages or dedicated features on a mobile application such as instant messages. As another example, a check-in notification can also be received directly by an access administrator by the physical presence of the user, and the access administrator may be able to manually override or otherwise enter the check-in notification into the system via the access administrator device, for example. Providing a check-in notification can also include displaying, on the mobile device, a code or other indication that can be provided to an access administrator at the access point to enter it or scan it on the access administrator's device. Any other alternative that allow the user to proof their presence at the place of interest could be considered in order to provide a check-in notification.

A check-in notification can be considered valid depending on various factors. For example, a check-in notification can be considered valid if a preauthorization for the mobile device associated with the check-in is already stored in the database, as explained with reference to steps 101-104 of flow chart 100. The validation of the check-in notification can be predicated on location information for the mobile device. In this way, if a user attempts to check-in but location information, such as information obtained from the mobile device's GPS, indicates that the mobile device is not within an acceptable range, the check-in notification can be considered not valid. In specific embodiment of the invention, the system could query an external database for location information for the access point. The system can access the external database via an API, and corresponding API key. The validation of the check-in notification can be predicated using the location information for the access point from the external database and location information from the mobile device. In the example of the open house, the system could access an MLS database to obtain the address of a given listing and obtain the current location of the mobile device. Then, the system could determine if the check-in notification is valid depending on how close the two locations are, for example.

The check-in notification can also be validated predicated on temporal information. For example, the system can only allow check-ins during a predetermined time, such as a time set by the access administrator. The time can be defined by the general hours for visitors to access the access point or a determined window allocated for a certain user. In the example of the open house, the agent can set the hours that the house will be open for visits, and users attempting to check-in for a visit out of the pre-set hours can have the check-in denied or deemed not valid. Also, the system can allow a maximum number of users per period of time, in order to avoid agglomerations and long waits outside of the house. In those cases, the system can assign groups of users a period of time to visit the house, and users attempting to check-in for a visit out of their assigned time can have the check-in denied or deemed not valid, and may have to wait for the next available time slot to check-in.

The check-in notification can be validated based on other numerous factors as determined by the access administrator. For example, users may be required to take a picture of themselves at the access point wearing a mask to provide mask compliance, if a mask is required to enter the access point. Users may be required to provide picture of a body temperature measurement taken outside of the access point. Users may be required to undergo a physical examination before they access the access point, for example, users may be required to use a thermometer, breathalyzer, and the like, and the system can be configured to deem the check-in not valid if the measurements exceed a predetermined value.

When a valid check-in notification is received from a mobile device, and a preauthorization for the mobile device is already stored in the database, an access schedule can be generated and/or updated by the system, for example by scheduler 230. The access schedule can be a schedule for users to access an access point and can be updated considering various parameters. When preauthorization requests have been validated for multiple users and/or their associated mobile devices, the access schedule can be useful in determining the order in which the users can access the access point. When users arrive to the access point of interest and provide a valid check-in notification, for example from their mobile device, the system (and access administrator) can be aware that a user is already at the given location and ready to access the access point. The system can then update the access schedule considering that the user arrived and is waiting to access, for example to give the user a position on a list or queue in accordance with the access schedule. An access administrator can be sent an alert or notification about the change in the access schedule. If a second user arrives at the access point, and also provides a valid check-in notification, the system can then update the access schedule considering that the second user arrived and is waiting to access, given that a second user/mobile device preauthorization is stored in the database in the same manner as was explained with reference to steps 101-104 of flow chart 100. The system can update the access schedule by placing the second user/mobile device in the queue, where the first user/mobile device is placed first. The access schedule can be updated for numerous users/mobile devices in the same manner as described above.

The access schedule can be dynamically updated based on numerous factors. For example, and as explained before, the schedule can be updated as preauthorized users check in and following the check-in order. Additionally, an access administrator can override the order or otherwise update the schedule, such as by manually altering the order of the users on the list. The access schedule can also be dynamically updated due to a user cancelation. For example, a user who checked-in could cancel through an application on their phones or other interface, and the schedule can be dynamically updated to remove the user from the list and assign a new position to other users. The access schedule can also be updated if it is determined that a user has left the vicinity. For example, if a user checked-in and then it is detected by the system that the user is driving away from the access points, for example by using the GPS on the mobile device, the schedule can be updated to remove the user from the list and assign a new position to other users. The user can be provided with an alert indicating that the place in the line can be lost before the access schedule is updated.

The access schedule can also be dynamically updated when the system receives an access point release notification. The release notification can be received from a mobile device, such as an access administrator mobile device, or a user mobile device, when the user has finished visiting or accessing the access point. For example, the access administrator can indicate through an interface on an application on their mobile device that a first user has finished their visit, the turn for the next user can be triggered and the system can update the access schedule accordingly. The access schedule can also be updated if it is determined that a user with a disability has checked-in. A user profile may indicate a special condition for a user, such as an elderly or ill person, and the system can be configured to automatically place such users at the beginning of the line.

In specific embodiments of the invention, users are provided with information when they provide a check-in notification, for example, the system can inform the user about the waiting time, and/or their position on the list. The information can be provided via the user's mobile devices, on a shared screen on the access point, via a text message, automatic call, etc. Users can be notified of an approximate window when they can expect to access the access point. The windows, positions, and/or waiting times can be updated and notifications can be sent to the users accordingly.

Flow chart 100 continues with a step 106 of transmitting an access notification to the first mobile device in accordance with the access schedule. Users waiting for their turn to access the access point can receive a notification, for example a notification from an application, a text message, an e-mail, a call, and the like, when it is their turn to access the access point. The notification can be sent to the next user in the access schedule in response to an indication from the access administrator that a previous user has finished their visit. When the user receives the access notification the user can enter the access point and the access schedule can be updated accordingly. Notifications can be sent to other users in line to inform them of their new position, waiting time, etc.

When the users receive an access notification, they can start their visit to the access point. At this point, the process described with reference to flow chart 100 can be completed, the agent can be in possession of the user's information and documents, and the visit can start immediately with no need of further forms or signing sheets. Specific embodiments in accordance with the system and method disclosed herein can be advantageous in that the access process can be speeded up since the user and access administrator do not need to spend additional time signing and reviewing documents. This process can also be advantageous in special circumstances such as under the COVID-19 sanitizing and social distancing requirements, where an access administrator could have to be in touch with and clean accessories, such as pens, used by multiple users.

In specific embodiments of the invention, an access token can be transmitted to the user mobile device in accordance with the access schedule. The access token can be provided as a security measure to allow the users to prove their identity. The access token can be displayed on the user's mobile device, for example as a visual code. The access token can be transmitted from the user's mobile device to an access administrator mobile device, for example via NFC signal. Alternatively, the token can be manually checked by an access administrator or checked via a dedicated token device. The token can also be sent to the access administrator via text message, e-mail, an application on the mobile device, etc. The token can also be automatically detected and verified by an application on the user's mobile device when received, and the user's mobile device can provide an indication that the token has been verified, such as a message on the screen, or sent a notification directly to the access administrator.

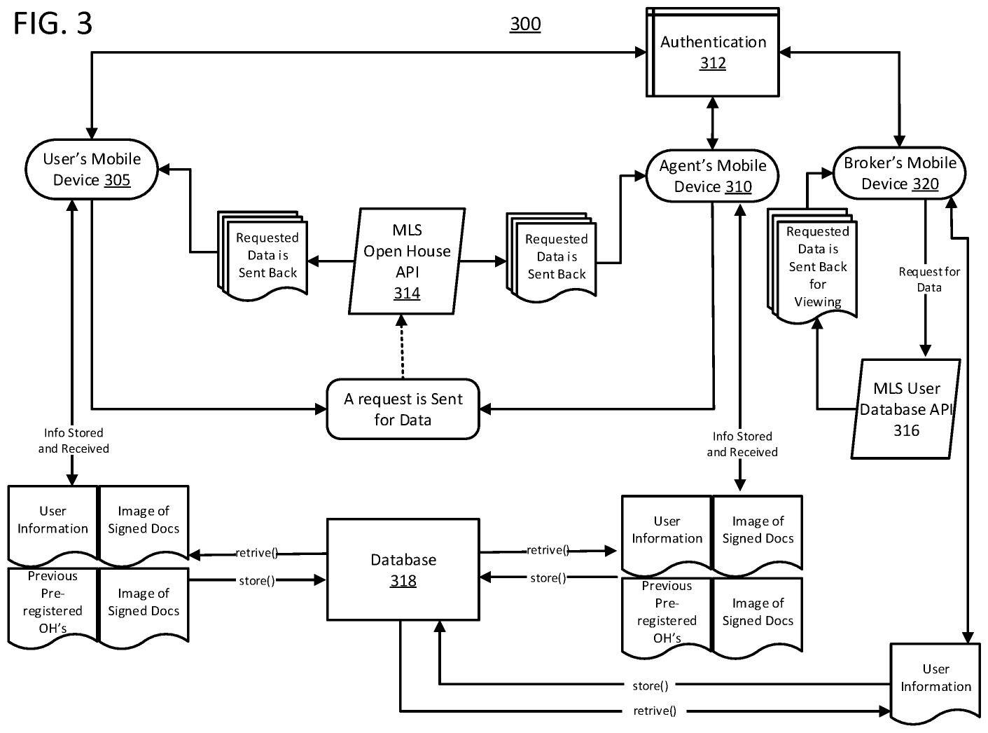

FIG. 3 illustrates a block diagram 300 of an example of the flow of information stored and retrieved from different mobile devices and databases of a system, in accordance with specific embodiments of the invention. An example of an open house is used for illustrative purposes. In block diagram 300, it is illustrated that a user device 305 and an agent device 310 can send requests for data. The requests can be processed by an MLS Open House API 314 and the requested data can be sent back to the devices. In specific embodiments of the invention, the data can be sent to the devices for viewing, and not sent to a database for further storage. Information such as user information, signed documents or documents for signature, pre-registered open houses, etc. can be stored in the user's device 305, the agent device 310 and/or a database, such as database 318. Database 318 can be a cloud database, proprietary or not. Information stored in the database can be accessed directly by the devices by querying the database and the use of commands such as store( ) and retrieve( ). In this way, documents can be stored, for example from the user's device 305, such as forms or signed documents, and accessed by an agent at a later time for review. The communication with the database could be made via an application running on the mobile devices.

Block diagram 300 also illustrates authentication module 312 in communication with the mobile devices. Authentication module 312 can store all the accounts and related information, such as e-mails, verifications, etc. In specific embodiments of the invention, authentication module 312 is used merely for sign up and log in features, and all other usable data is stored in a database, such as database 318. Authentication module 312 can include a database, servers, processors and other infrastructure necessary to provide authentication and storage services. Block diagram 300 also illustrates a broker's mobile device 320. The broker device can request for data to an MLS user database 316 and the requested data can be sent back to the device for viewing. Agents and listings from a broker as stored in MLS can be automatically added to the system at the brokers request.

In specific embodiments of the invention, the system offers the possibility for an access administrator to track users who have accessed the access point. This feature can be advantageous in that access administrators can request feedback from the users and guide users with additional steps. The system can also offer the possibility for a user to keep track of the visited access points so that users can keep a record of their activities. Users can be able to request additional information's, disclosures, schedule a second visit, get connected with an access administrator, such as an agent, etc.

In the example of the open house, if the user is working with an agent who is not the agent administering the open house, the user's agent can receive notifications and get involved in the process. Users can be provided with options to introduce their agent's information which can be sent, along with the user information, to the agent administering the open house. If the user's agent does not have an account or is not registered in the system, the agent can be provided with a link or invitation to register and become an active member. In a similar way, if an agent administering an open house is not registered in the system, but the open house is listed in third party platforms that offer the possibility to request preauthorization via the system, a notification can be sent to the agent when a user attempts to request preauthorization, and the agent can get invited to register to administer the open house via the system as described with reference to flow chart 100. Alternatively or in combination, open houses uploaded by agents into public platforms can be automatically linked to the system and displayed via a system dedicated interface in a phone application, web page, etc. A user can either request preauthorization if the agent is part of the system or send the agent a request for the agent to register in the system.

In specific embodiments of the invention, when a user is scheduled for multiple visits on a single day, the user can be routed, for example by an application of the user's mobile device, in the most efficient order of visits. The system can retrieve the addresses for the different access points and create a route considering the user's current or departing location. The user can also be routed depending on the waiting on each access point. For example, if two access points are relatively close to each other, the application can route the user to the one that has a smaller waiting time. Access administrators can also control the flow of visitors by controlling the scheduling or setting limits for the number of users that can be waiting at a given access point at the same time. Users can be notified accordingly and proceed to the access point when access is allowed.

While the specification has been described in detail with respect to specific embodiments of the invention, it will be appreciated that those skilled in the art, upon attaining an understanding of the foregoing, may readily conceive of alterations to, variations of, and equivalents to these embodiments. The systems and methods disclosed herein can provide a secure experience, where the contact between users and access administrators is reduced, which can be advantageous in many different scenarios, such as when facing contagious diseases as COVID-19. Although the example of an open house was used throughout this disclosure, the systems and methods disclosed are widely applicable to administrate access to other access points such as hospitals, doctor's offices, gyms, restricted areas, and the like. These and other modifications and variations to the present invention may be practiced by those skilled in the art, without departing from the scope of the present invention, which is more particularly set forth in the appended claims.

What is claimed is:

1. A computer-implemented method comprising:
receiving a preauthorization request associated with a verified entity account and a first access point;
executing, in response to receiving the preauthorization request, a preauthorization request validation flow for the verified entity account;
validating, in response to a completion of the preauthorization request validation flow, the preauthorization request;
storing, in response to validating the preauthorization request, a first mobile device preauthorization in a database for a first mobile device, wherein the first mobile device is associated with the verified entity account;
dynamically updating, predicated on the first mobile device preauthorization being stored in the database and in response to receiving a valid check-in notification from the first mobile device, an access schedule for the first access point; and
transmitting an access notification to the first mobile device in accordance with the access schedule.

2. The computer-implemented method of claim 1, further comprising:
receiving an access point release notification from a second mobile device; and
dynamically updating, in response to receiving the access point release notification, the access schedule for the first access point.

3. The computer-implemented method of claim 1, further comprising:
transmitting an access token to the first mobile device in accordance with the access schedule.

4. The computer-implemented method of claim 3, further comprising one of:
displaying the access token as a visual code on the first mobile device; and
transmitting the access token from the first mobile device to a second mobile device using a near field communication signal.

5. The computer-implemented method of claim 1, further comprising:
receiving location information for the first mobile device; and
predicating validation of the check-in notification on the location information.

6. The computer-implemented method of claim 5, further comprising:
querying an external database for location information for the first access point using a web applications programming interface key; and
wherein the predicating validation of the check-in notification is conducted using the location information for the first access point and the location information for the first mobile device.

7. The computer-implemented method of claim 1, further comprising:
receiving temporal information for the first access point; and
predicating validation of the check-in notification on the temporal information.

8. The computer-implemented method of claim 1, further comprising:
receiving, with respect to the first access point, a preauthorization flow definition to define requirements for the preauthorization request validation flow.

9. The computer-implemented method of claim 1, further comprising:
storing, in response to validating a second preauthorization request, a second mobile device preauthorization in the database for a second mobile device, wherein the second mobile device is associated with a second verified entity account;
dynamically updating, predicated on the second mobile device preauthorization being stored in the database and in response to receiving a second valid check-in notification from the second mobile device, the access schedule for the first access point; and
transmitting a second access notification to the second mobile device in accordance with the access schedule.

10. The computer-implemented method of claim 1, wherein the preauthorization request is initiated by one of:
a visually displayed encoding at the first access point;
a hyperlink on an external web page; and
a user interface element on an application interface on the first mobile device.

11. A non-transitory computer-readable media accessible to one or more processors and storing instructions which, when executed by the one or more processors, implement a method comprising:
receiving a preauthorization request associated with a verified entity account and a first access point;
executing, in response to receiving the preauthorization request, a preauthorization request validation flow for the verified entity account;
validating, in response to a completion of the preauthorization request validation flow, the preauthorization request;
storing, in response to validating the preauthorization request, a first mobile device preauthorization in a database for a first mobile device, wherein the first mobile device is associated with the verified entity account;
dynamically updating, predicated on the first mobile device preauthorization being stored in the database and in response to receiving a valid check-in notification from the first mobile device, an access schedule for the first access point; and
transmitting an access notification to the first mobile device in accordance with the access schedule.

12. The non-transitory computer-readable media of claim 11, wherein the method further comprises:
receiving an access point release notification from a second mobile device; and
dynamically updating, in response to receiving the access point release notification, the access schedule for the first access point.

13. The non-transitory computer-readable media of claim 11, wherein the method further comprises:
transmitting an access token to the first mobile device in accordance with the access schedule.

14. The non-transitory computer-readable media of claim 13, wherein the method further comprises one of:
displaying the access token as a visual code on the first mobile device; and
transmitting the access token from the first mobile device to a second mobile device using a near field communication signal.

15. The non-transitory computer-readable media of claim 11, wherein the method further comprises:
receiving location information for the first mobile device; and
predicating validation of the check-in notification on the location information.

16. The non-transitory computer-readable media of claim 15, wherein the method further comprises:
querying an external database for location information for the first access point using a web applications programming interface key; and
wherein the predicating validation of the check-in notification is conducted using the location information for the first access point and the location information for the first mobile device.

17. The non-transitory computer-readable media of claim 11, wherein the method further comprises:
receiving temporal information for the first access point; and
predicating validation of the check-in notification on the temporal information.

18. The non-transitory computer-readable media of claim 11, wherein the method further comprises:
receiving, with respect to the first access point, a preauthorization flow definition to define requirements for the preauthorization request validation flow.

19. The non-transitory computer-readable media of claim 11, wherein the method further comprises:
storing, in response to validating a second preauthorization request, a second mobile device preauthorization in the database for a second mobile device, wherein the second mobile device is associated with a second verified entity account;
dynamically updating, predicated on the second mobile device preauthorization being stored in the database and in response to receiving a second valid check-in notification from the second mobile device, the access schedule for the first access point; and
transmitting a second access notification to the second mobile device in accordance with the access schedule.

20. The non-transitory computer-readable media of claim 11, wherein the preauthorization request is initiated by one of:
a visually displayed encoding at the first access point;
a hyperlink on an external web page; and
a user interface element on an application interface on the first mobile device.

21. A system comprising:
a mobile device;
a database;
one or more processors; and
one or more non-transitory computer-readable media accessible to the system, and
storing instructions which, when executed by the system, cause the system to:
receive a preauthorization request associated with a verified entity account and an access point, wherein the verified entity account is associated with the mobile device;
execute, in response to receiving the preauthorization request, a preauthorization request validation flow for the verified entity account;
validate, in response to a completion of the preauthorization request validation flow, the preauthorization request;
store, in response to validating the preauthorization request, a preauthorization for the mobile device in the database;
receive a valid check-in notification from the mobile device;
dynamically update, predicated on the preauthorization for the mobile device being stored in the database and in response to receiving the valid check-in notification, an access schedule for the access point; and
transmit an access notification to the mobile device in accordance with the access schedule.
